(19) United States
(12) Patent Application Publication
(10) Pub. No.: US 2006/0218847 A1
(43) Pub. Date: Oct. 5, 2006

(54) Protective fishing hook eye cover

(76) Inventor: Hirofusa Otsubo, Elmhurst, NY (US)

Correspondence Address: Hirofusa Otsubo, 60-16 83rd Place, Elmhurst, NY, 11373, US

(21) Appl. No.: 11/097,541

(22) Filed: Apr. 2, 2005

(51) Int. Cl. A01K 83/00

(52) U.S. Cl. 43/44.83; 43/43.16

(57) ABSTRACT

Another embodiment of the present invention describes a fishing hook having an eye for attaching a fishing line to, wherein the hook eye is configured with a cover, covering at least a portion of the eye, which cover is operable to protect a fishing line that is knotted thereupon from making direct contact with the surface of the hook eye. The cover can be a sleeve or a coating, and made of a compliant material such as plastic or rubber.

### FIELD OF THE INVENTION

The present invention relates generally to fishing hooks. More particularly, the invention relates to fishing hooks adapted with means to between the fishing line knotted onto the eye of a fishing hook.

### BACKGROUND OF THE INVENTION

In the field of sport fishing, an important part of fishing line knot tying is at the hook eye, which is typically made of metal, where violent jolts occur as the fish struggles to free itself. FIG. 1 illustrates an exemplary conventional fishing hook having a hook eye 5. Conventional approaches to joining the fishing line and metal hook eye results in significant fishing line, and over time, may result in breaking the fishing line from the hook. This poor joining means is well known to be one of the most common reasons for unsuccessful fish catching; that is, when the hook breaks off from leader line at the hook eye area because of deformation of leader line by slipping away from knot because of the two very different materials—the relatively soft, flexible plastic leader line and the hard steel slippery surface of hook eye. Moreover, conventional hook eyes and fishing line knots are known to be susceptible to the fishing line knot becoming undone because of the hook eye's slippery steel surface. This fishing line slip also tends to creates fatigue leading to breakage by thinning the fishing line at the slipping contact point. Given that it is very uncommon that the middle of fishing line breaks upon initially engaging the fish, an improvement in the joining of the fishing line and eye to avoid line fatigue breakage by its slip away from hook eye could significantly improve the overall success rate of catching fish.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of an exemplary conventional fishing hook;

FIG. 2a illustrates a side view of an exemplary eye cover covering the exemplary hook's eye, in accordance with an embodiment of the present invention;

FIG. 2b illustrates a side view of fishing line knotted onto the anti-knot slip and cushion eye sleeve embodiment of FIG. 2a, in accordance with an embodiment of the present invention;

FIG. 3 illustrates a front view of a non-integral, eye cover sleeve, in accordance with an embodiment of the present invention.

FIG. 4 illustrates a side view of FIG. 3 eye sleeve shown from the left side view relative to FIG. 3, in accordance with an embodiment of the present invention;

FIG. 5 illustrates a side view of an exemplary fishing lure eyes enhanced, hook eye cover comprising eyes, in accordance with an embodiment of the present invention.

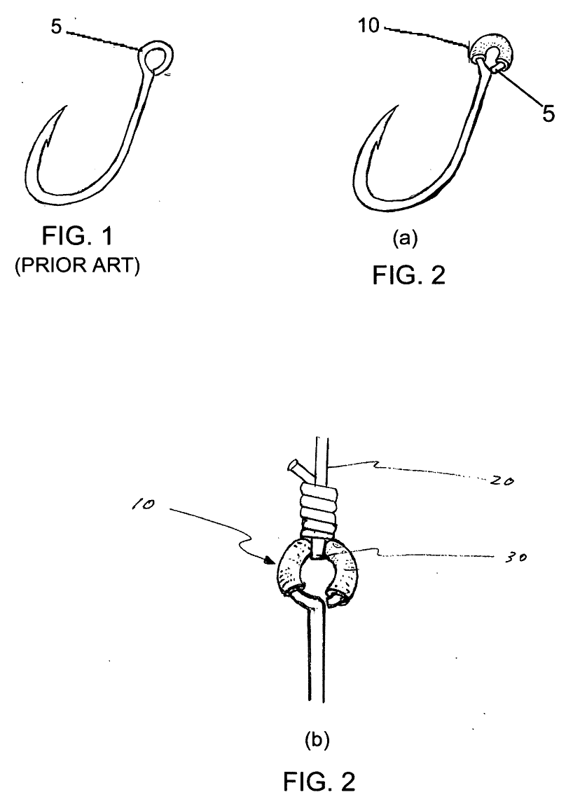

Unless otherwise indicated illustrations in the figures are not necessarily drawn to scale.

### SUMMARY OF THE INVENTION

To achieve the forgoing and other objects and in accordance with the purpose of the invention, a variety of techniques for protectively covering a fishing hook eye are described.

A protective fishing hook eye cover is provide, which, in one embodiment, includes means for protectively covering at least a portion of a fishing hook eye to protect a fishing line from being cut by the eye of a hook (e.g., a protective sleeve or coating), and means for joining the hook eye covering means to a hook eye. Some embodiments further include means for configuring the hook eye covering means to appear as a fishing lure.

Another embodiment of the present invention describes a fishing hook having an eye for attaching a fishing line to, wherein the eye is configured with a cover covering at least a portion of the eye, which cover is operable to protect a fishing line that is knotted thereupon from making direct contact with the surface of the hook eye. The cover can be made of a compliant material such as plastic or rubber.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

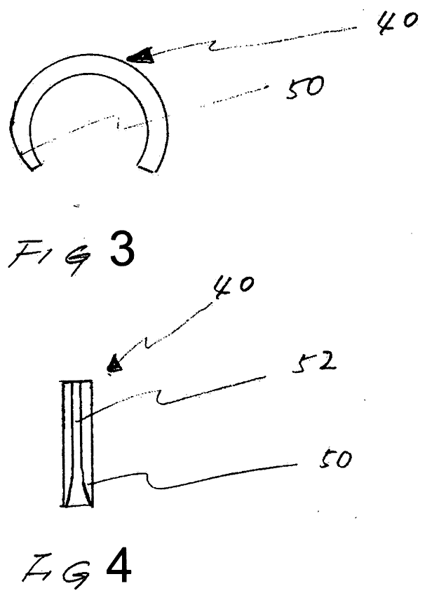

FIG. 2a illustrates a side view of an exemplary transparent anti-friction eye cover 10 covering the exemplary hook's eye, in accordance with an embodiment of the present invention. Eye cover 10 may be composed of any material that smooth and compliant enough to have reduced line deformation by slipping away from knot through hook eye and preferably also absorb jolting forces with its cushion effect, while being resilient enough to sufficiently endure the continuous jolting forces from the fishing line without slip. Suitable materials to form eye cover 10 include, but are not limited to, plastic and rubber. In some application, the compliant aspect of the eye cover may not be required, whereby the material used may be substantially non-compliant. In some embodiments, eye cover 10 is a plastic tube, or sleeve, that is slid over or pushed onto eye 5. In alternate embodiments eye cover 10 becomes an integral part of the hook by way of being a coating (e.g., plastic, rubber, etc.) that is applied onto eye 5 of fishing hook to support relatively stronger leader line knot tying onto the hook. Any conventional means of applying a coating may be used; by way of example, and not limitation, spraying on molten material, molding, or dipping into molten material.

FIG. 2b illustrates a side view of a fishing line 20 knotted onto eye cover embodiment of FIG. 2a, in accordance with an embodiment of the present invention. A knot loop 30 is looped around the upper portion of eye 5, and is the tightening portion of the noose formed by fishing line 20 knot just above eye 5. One aspect of the foregoing embodiments is that as the hook is pulled away from fishing line 20 the noose tightens knot loop 30 onto the compliant eye cover 10, thereby squeezing the eye cover not shown), to some degree, into an annular depression that tends to restrict knot loop 30's lateral and rotational degrees of freedom. This squeezing of the compliant eye cover 10 acts as a shock absorber and also helps to constrain fishing line knot loop 30 from sliding away from the knot, thereby further strengthening the knot that tends to slip off in conventional approaches. Another aspect of the present embodiment is that as knot loop 30 squeezes into eye cover 10 they both tend to bind against one another, which tends to prevent the fishing line knot from slipping, and becoming unknotted under the typically high forces involved in catching large fish. It should be appreciated that the convention hook and fishing line shows is completely exemplary, and those skilled in the art will readily recognize how to apply the teachings of the present invention to properly adapt any suitable hook and fishing line accordingly, including, but not limited to, lures, fishing jigs, swivels, and fly fishing hooks.

In embodiments were eye cover 10 is a movable sleeve, it should be appreciated that eye cover 10 is able to rotate around hook eye 5 and absorb the frictional forces between knot loop 30 and hook eye 5, thereby further reducing, or eliminating, the cutting friction that knot loop 30 would otherwise experience. Those skilled in the art will also know how to apply conventional techniques in light of the teachings of the present invention, to properly configure eye cover to act as a fishing lure e.g., appear like a piece of edible food to a fish).

FIG. 3 illustrates a side view of a non-integral, anti-friction eye sleeve 40, in accordance with an embodiment of the present invention. In the embodiment shown, the outer end portion of the left side has a tapered end 50 that has a gradual reduction of the sleeves diameter as it reaches the left end of eye sleeve 40.

FIG. 4 illustrates a side view of eye sleeve 40 shown from a left side view of FIG. 3, in accordance with an embodiment of the present invention. As shown in the Figure, there is a lengthwise gap 52, which comprises tapered end 50 at the bottom i.e., left end of FIG. 3). In the preferred embodiment, lengthwise gap 52 is generally centered, and of uniform width until it reaches tapered end 50, wherein the gap gradually increases in width as it approaches the tapered end of eye sleeve 40. In some application, tapered end 50 facilitates mounting of eye sleeve 40 on to eye of a hook from inside by pushing it against eye of hook at tapered end 50 first and then gradually inserting the eye along the length of eye sleeve 40 until the opposite end is reached. In most applications, eye sleeve 40 is preferably centered at the location where the fishing line is typically joined to the hook's eye when in normal use. Alternate embodiments of the present invention may not include a gap and/or tapered end, and may, instead, be a simple sleeve the open end of the hook eye slides into. In light of the present teachings, those skilled in the art will readily recognize a multiplicity of known techniques for adapting the present hook eye sleeve to facilitate the properjoining thereof onto the hook's eye.

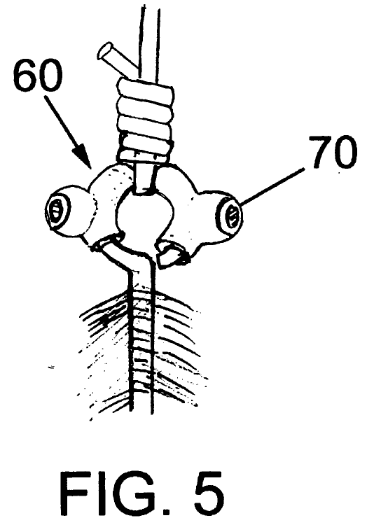

In some embodiments, especially the non integral types, of the present eye cover it may be desirable to add a multiplicity of known or novel features that are either aesthetically pleasing or are fishing performance oriented. By way of example, FIG. 5 illustrates a side view of an exemplary fishing lure eyes enhanced, hook eye cover 60 comprising eyes 70, in accordance with an embodiment of the present invention. Fishing lure eyes enhanced, hook eye cover 60 is substantially the same as in the prior Figures, except for the addition of ornamental eyes 70, which, in one aspect, helpful to give the overall hook and hook eye cover combination the appearance of being food to fish. Such lure enhancements are at least applicable to flies for fly shining, such as, for example, creating Nymphs, Admas, Duns, and Caddis.

In light of the teachings of the present invention, those skilled in the art will readily recognize that eye cover of the present invention may be configure in a multiplicity of alternate ways depending on the needs of the particular application. Having fully described at least one embodiment of the present invention, other equivalent or alternative methods of protectively covering hook eyes according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. A protective fishing hook eye cover comprising:
a. means for protectively covering at least a portion of a fishing hook eye to protect a fishing line from being cut by the eye of a hook; and
b. means for joining said hook eye covering means to a hook eye.

2. The protective fishing hook eye cover of claim 1 further comprising means for configuring said hook eye covering means to appear as a fishing lure.

3. A fishing hook with a protective eye cover comprising:
a. a fishing hook, the hook having an eye for attaching a fishing line to; and
b. a cover covering at least a portion of the eye, which cover is operable to protect a fishing line that is knotted thereupon from making direct contact with the surface of the hook eye.

4. The protective fishing hook eye cover of claim 3, wherein said cover is made of a compliant material.

5. The protective fishing hook eye cover of claim 4, wherein said compliant material is plastic or rubber.

6. The protective fishing hook eye cover of claim 3, wherein said cover is an applied coating.

7. The protective fishing hook eye cover of claim 3, wherein said cover is a sleeve.

8. The protective fishing hook eye cover of claim 7, wherein said sleeve comprises a lengthwise slit for pressing said sleeve onto the eye of the hook.

9. The protective fishing hook eye cover of claim 8, wherein said lengthwise slit has a tapered end portion that has an increasing gap width as it approaches the corresponding end of said sleeve.

10. The protective fishing hook eye cover of claim 3 further comprising means for configuring said hook eye cover to appear as a fishing lure.

11. A protective fishing hook eye cover comprising:
a sleeve configured to cover at least a portion of the eye of a fishing hook, which cover is operable to protect a fishing line that is knotted thereupon from making direct contact with the surface of the hook eye.

12. The protective fishing hook eye cover of claim 1, wherein said sleeve is made of a compliant material.

13. The protective fishing hook eye cover of claim 12, wherein said compliant material is plastic or rubber.

14. The protective fishing hook eye cover of claim 11, wherein said sleeve comprises a lengthwise slit for pressing said sleeve onto the eye of the hook.

15. The protective fishing hook eye cover of claim 14, wherein said lengthwise slit has a tapered end portion that has an increasing gap width as it approaches the corresponding end of said sleeve.

16. The protective fishing hook eye cover of claim 11 further comprising means for configuring said hook eye cover to appear as a fishing lure.
